(19) United States
(12) Patent Application Publication
(10) Pub. No.: US 2025/0391213 A1
(43) Pub. Date: Dec. 25, 2025

(54) PRIORITY-BASED DATA MIGRATION FOR A VEHICLE

(71) Applicant: QUALCOMM Incorporated, San Diego, CA (US)

(72) Inventors: Sang Tran, Encinitas, CA (US); Rongtian Zhang, San Diego, CA (US); Hung Vuong, Coronado, CA (US)

(21) Appl. No.: 18/752,243

(22) Filed: Jun. 24, 2024

(51) Int. Cl. G07C 5/08; H04L 12/40

(52) U.S. Cl. CPC G07C 5/085; H04L 12/40163

(57) ABSTRACT

A processing system includes one or more memories and one or more processors coupled to the one or more memories. The processing system is configured to obtain first data associated with a vehicle and to obtain second data associated with the vehicle. The first data is associated with a first priority level, and the second data is associated with a second priority level. The processing system is further configured to store the first data to a nonvolatile memory of the vehicle in accordance with detection of a data migration trigger event and further in accordance with a prioritization scheme that prioritizes the first data over the second data upon occurrence of the data migration trigger event.

### TECHNICAL FIELD

Aspects of the disclosure relate generally to data storage for vehicles.

### DESCRIPTION OF THE RELATED TECHNOLOGY

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles may lead to unfortunate incidents resulting from the collision of vehicle with vehicle, vehicle with object, vehicle with human, or vehicle with animal. As research into vehicle automation has progressed, a variety of automated driving systems have been produced and introduced. These include navigation directions by GPS, adaptive cruise control, lane change assistance, collision avoidance systems, night vision, parking assistance, blind spot detection, lane keeping assistance, automated braking, partially autonomous driving, and fully autonomous driving.

As automated driving systems have progressed, so too have requirements for computing capacity to support such automated driving systems. Vehicles may include multiple computing systems, which may be general-purpose or tailored to specific automated driving functions. Furthermore, such computing systems may be designed to meet varying safety standards, depending on the features supported by such computing systems. As a result, cost, complexity, and power consumption associated with automated driving systems may be significant in some vehicles.

### SUMMARY

The systems, methods and devices of this disclosure each have several innovative aspects, no single one of which is solely responsible for the desirable attributes disclosed herein.

In some aspects, a processing system includes one or more memories and one or more processors coupled to the one or more memories. The processing system is configured to obtain first data associated with a vehicle and to obtain second data associated with the vehicle. The first data is associated with a first priority level, and the second data is associated with a second priority level. The processing system is further configured to store the first data to a nonvolatile memory of the vehicle in accordance with detection of a data migration trigger event and further in accordance with a prioritization scheme that prioritizes the first data over the second data upon occurrence of the data migration trigger event.

In some further aspects, a method includes obtaining first data associated with a vehicle and further includes obtaining second data associated with the vehicle. The first data associated with a first priority level, and the second data is associated with a second priority level. The method further includes storing the first data to a nonvolatile memory of the vehicle in accordance with detection of a data migration trigger event and further in accordance with a prioritization scheme that prioritizes the first data over the second data upon occurrence of the data migration trigger event.

In some additional aspects, a non-transitory computer-readable medium stores instructions executable by one or more processors to perform operations. The operations include obtaining first data associated with a vehicle and further include obtaining second data associated with the vehicle. The first data associated with a first priority level, and the second data is associated with a second priority level. The operations further include storing the first data to a nonvolatile memory of the vehicle in accordance with detection of a data migration trigger event and further in accordance with a prioritization scheme that prioritizes the first data over the second data upon occurrence of the data migration trigger event.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a perspective view of a vehicle that supports priority-based data migration.

FIG. 2 shows a block diagram of an example system that supports priority-based data migration for a vehicle, such as the vehicle of FIG. 1

FIG. 3 shows a block diagram of another example system that supports priority-based data migration for a vehicle, such as the vehicle of FIG. 1.

FIG. 4 shows a block diagram of an example of a data structure that supports priority-based data migration for a vehicle, such as the vehicle of FIG. 1.

FIG. 5 is a flow chart illustrating an example method that supports data migration for a vehicle, such as the vehicle of FIG. 1.

Like reference numbers and designations in the various drawings indicate like elements.

### DETAILED DESCRIPTION

In some aspects of the disclosure, data associated with operation of a vehicle may be prioritized into critical data and noncritical data in accordance with a priority scheme. The critical data may indicate, for example, one or more of a state of the vehicle or a state of a driver of the vehicle that may be useful in identifying a cause of an accident or circumstances associated with the accident. The critical data may be stored to a volatile memory of the vehicle. In some examples, the volatile memory may include a circular buffer or a ping-pong buffer.

In accordance with detection of a data migration event, the critical data may be migrated (e.g., copied or transferred) from the volatile memory to a nonvolatile memory of the vehicle. In some examples, the critical data may be migrated to the nonvolatile memory in accordance with another priority scheme. For example, the most recent critical data may be migrated to the nonvolatile memory before less recent critical data (such as in accordance with a last-in, first-out (LIFO) policy) or by prioritizing one or more data types over one or more other data types for migration to the nonvolatile memory. Further, in some examples, the critical data may be migrated to the nonvolatile memory using a dedicated command that indicates the nonvolatile memory is to prioritize writing the critical data over one or more other operations, such as writing or reading noncritical data. In some examples, the critical data may be stored to a secure storage region of the nonvolatile memory, such as a replay protected memory block (RPMB) storage region, which may secure the critical data from a malicious actor (such as a hacker).

By migrating data from the volatile memory to the nonvolatile memory, data may be more likely to be preserved in case of power loss to the volatile memory (which may occur, for example, due to an accident or due to disconnection of a battery of the vehicle). In some examples, the data may be used to investigate a cause of an accident. In some other examples, the data may be used in connection with vehicle diagnostics or performance evaluation, as illustrative examples. Accordingly, one or more features described herein may enable critical data to may be prioritized and preserved for a variety of different uses.

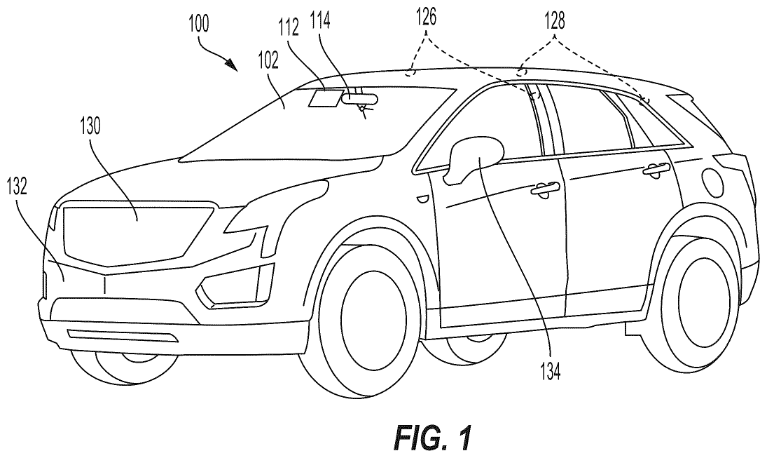

FIG. 1 is a perspective view of a vehicle 100 that supports priority-based data migration. The vehicle 100 may include multiple sensors, such as a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or forward direction. In some embodiments, an additional camera may be located at the rear of the vehicle 100 and oriented such that the field of view of the additional camera captures a scene behind the vehicle 100 in the direction that the vehicle 100 is moving when in reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the operator is driving the vehicle 100 in a forward direction may likewise be obtained while the operator is driving the vehicle 100 in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term nonvolatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

The camera(s) of FIG. 1 may, along with other sensors, such as radar sensors, lidar sensors, and other sensors, provide sensed information to an assisted driving SOC of the vehicle 100. The assisted driving SOC may use the data for providing assisted or autonomous driving capabilities. In particular, the assisted driving SOC may receive data from one or more sensors of the vehicle 100 and may control one or more functions of the vehicle based on the received data, such as acceleration, braking, steering, blinker activation, headlight activation, wiper activation, and other functions. For example, the assisted driving SOC may provide assisted driving capabilities of up to, and exceeding, level 4 autonomous driving capabilities.

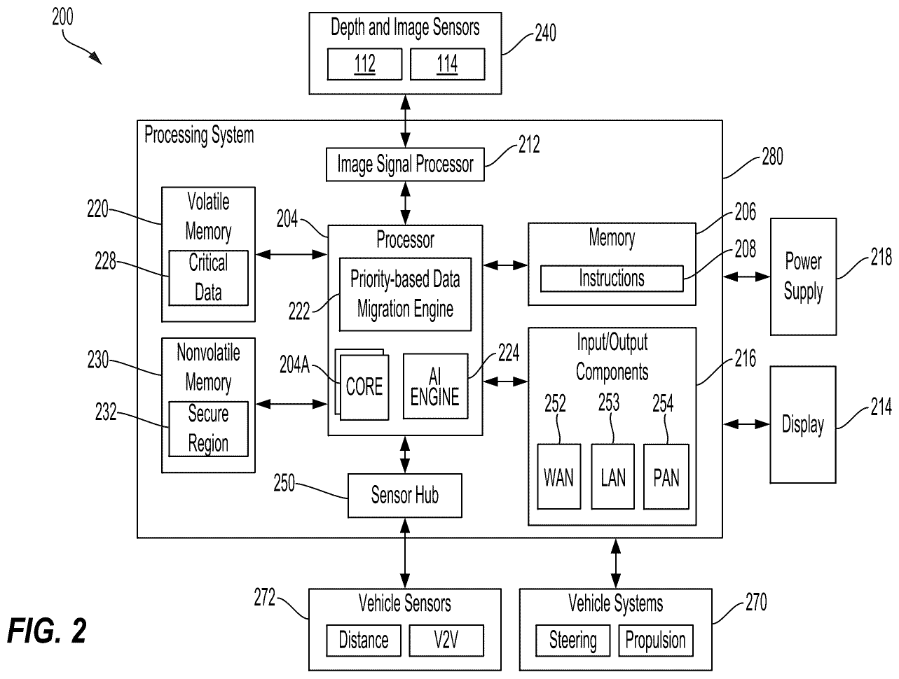

FIG. 2 shows a block diagram of an example system 200 that supports priority-based data migration for a vehicle, such as the vehicle 100 of FIG. 1. In some examples, the system 200 may be included in the vehicle 100 of FIG. 1. For example, the system 200 may correspond to a driver assistance system that is included in the vehicle 100 of FIG. 1.

The system 200 of FIG. 2 may include a processing system 280, such as a system-on-chip (SoC) or another type of processing system. The processing system 280 may include or may be coupled to an image signal processor 212 for processing image frames from one or more image sensors, such as depth and image sensors 240. The depth and image sensors 240 may include, for example, the cameras 112, 114 of FIG. 1.

In some implementations, the processing system 280 may include or may be coupled to a processor 204 (e.g., CPU) and a memory 206 storing instructions 208. In some embodiments, the processor 204 may include one or more neural signal processors, one or more graphics processing units (GPUs), one or more application processors, one or more computer vision processors, and one or more other processing units.

The system 200 may also include or be coupled to a display 214 and input/output (I/O) components 216. The I/O components 216 may be used for interacting with a user, such as via a touch screen interface and/or physical buttons. The I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The system 200 may further include or be coupled to a power supply 218, such as a battery or an alternator. The system 200 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image signal processor 212 and the depth and image sensors 240.

In some examples, the system 200 may include a sensor hub 250 for interfacing with sensors to receive data regarding movement of the vehicle 100 of FIG. 1, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as image data used to form image frames. In one embodiment, a local bus connection couples the image signal processor 212 to depth and image sensors 240, which may include or correspond to cameras 112, 114 of FIG. 1. In another embodiment, a wire interface may couple the image signal processor 212 to an external image sensor. In a further embodiment, a wireless interface may couple the image signal processor 212 to depth and image sensors 240.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed to generate images or videos. The instructions 208 may also include other applications or programs, such as an operating system, automated driving applications, mapping applications, or entertainment applications. Execution of the camera application, such as by the processor 204, may cause the vehicle 100 of FIG. 1 to generate images using the depth and image sensors 240 and the image signal processor 212. The memory 206 may also be accessed by the image signal processor 212 to store processed frames or may be accessed by the processor 204 to obtain the processed frames. In some embodiments, the processing system 280 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, risk map generation, driver monitoring, autonomous or assisted driving, and driver alert operations. For example, execution of the instructions can instruct the processing system to isolate one or more domains of the processing system 280, upon detection of a fault or error in another domain, as described herein. In some embodiments, the processor 204 may include one or more processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In some embodiments, the processor 204 may include one or more ICs or other hardware (e.g., an artificial intelligence (AI) engine 224) in addition to the ability to execute software to cause the vehicle 100 of FIG. 1 to initiate, perform, or control one or more operations described herein. In some other embodiments, the processing system 280 may not include the processor 204, such as when all of the described functionality is configured in the image signal processor 212. In some embodiments, the processing system 280 including the processor 204, the image signal processor 212, the sensor hub 250, the input/output components 216 and the memory 206 may be integrated in one or more SOCs, such as a automated driving SOC. Such an SOC may, for example, include multiple processors 204, one or more image signal processors 212, and other components. The SOC may also include one or more neural signal processing units, one or more graphics processing units (GPUs), one or more application processors, one or more computer vision processors, one or more display processors, one or more peripheral interfaces, such as ethernet, universal serial bus, or other interfaces, one or more sensors and/or sensor interfaces, one or more voltage supplies, one or more clock, one or more memory controllers such as one or more oscillators, and other components. In some embodiments, the processing system 280 may include one or more busses connecting components, such as the processor 204, the memory 206, and other components of the processing system 280. In some embodiments, the processing system 280 may include multiple processors and may be divided into multiple domains, as described herein. For example, multiple domains of the processing system may be configured to meet different safety standards, as described herein.

In some embodiments, the display 214 may include one or more suitable displays or screens allowing for user interaction and/or to present items to the user. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a bus of the vehicle 100 for providing commands and information to and receiving information from vehicle systems 270 including propulsion (e.g., commands to increase or decrease speed or apply brakes) and steering systems (e.g., commands to turn wheels, change a route, or change a final destination).

While shown to be coupled to each other via the processor 204, components (such as the processor 204, the memory 206, the image signal processor 212, the display 214, and the I/O components 216) may be coupled to each another in other various arrangements, such as via one or more local buses, which are omitted for simplicity. While the image signal processor 212 is illustrated as separate from the processor 204, the image signal processor 212 may be a core of a processor 204 that is an application processor unit (APU), included in a system on chip (SoC), or otherwise included with the processor 204. Additionally, other components, numbers of components, or combinations of components may be included in a suitable vehicle for performing aspects of the present disclosure. As such, the present disclosure is not limited to a specific device or configuration of components, including the vehicle 100.

In some implementations, the processor 204 may include or may execute a priority-based data migration engine 222. The processing system 280 may further include a volatile memory 220 and a nonvolatile memory 230. In some examples, the volatile memory 220 may be internal to the processor 204. In some other examples, the volatile memory 220 may be external to the processor 204. The volatile memory 220 may include a buffer, such as a circular buffer or a ping-pong buffer. Further, in some implementations, the volatile memory 220 may include a static random access memory (SRAM) or another type of memory. In some examples, the nonvolatile memory 230 may include or may correspond to a secure region 232.

The priority-based data migration engine 222 may store critical data 228 to the volatile memory 220. For example, the priority-based data migration engine 222 may receive data (e.g., from one or more of the depth and image sensors 240, the vehicle systems 270, or the vehicle sensors 272) and may identify the critical data 228 within the received data. The priority-based data migration engine 222 may store the critical data 228 to the volatile memory 220.

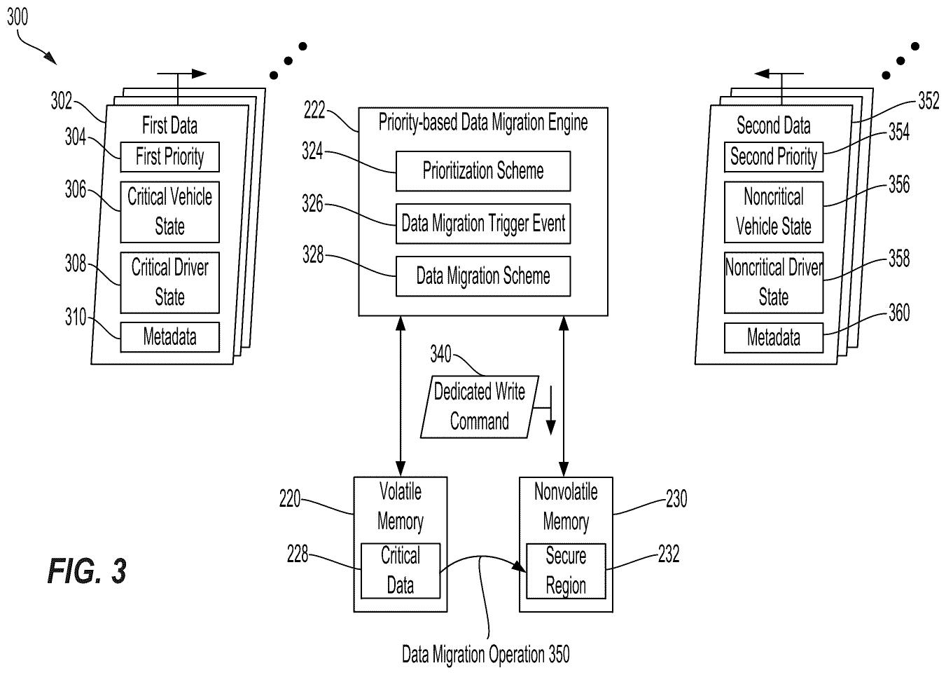

In some circumstances, the priority-based data migration engine 222 may detect a data migration trigger event. In accordance with detecting the data migration trigger event, the priority-based data migration engine 222 may selectively relocate the critical data 228 from the volatile memory 220 to the nonvolatile memory 230 (e.g., to the secure region 232). Some illustrative examples that may be associated with the priority-based data migration engine 222 are described further with reference to FIG. 3.

FIG. 3 shows a block diagram of another example system 300 that supports priority-based data migration for a vehicle, such as the vehicle 100 of FIG. 1. The system 300 of FIG. 3 may include the priority-based data migration engine 222, the volatile memory 220, and the nonvolatile memory 230. In some examples, the system 300 may correspond to a driver assistance system of the vehicle 100.

In some examples, the priority-based data migration engine 222 may be included in or executed by a processor, such as the processor 204 of FIG. 2 or another processor. The processor may be coupled to the volatile memory 220 and to the nonvolatile memory 230. In some examples, the system 300 may be included in a vehicle, such as the vehicle 100 of FIG. 1.

During operation, the priority-based data migration engine 222 may receive data associated with operation of the vehicle 100. The priority-based data migration engine 222 may receive the data from the depth and image sensors 240, from the vehicle sensors 272, from the vehicle systems 270, from one or more other components of the vehicle 100, or a combination thereof. The data may indicate one or more states of the vehicle 100, one or more states of a driver of the vehicle 100, or both. The data may include, for example, first data 302 and second data 352.

To illustrate, the one or more states of the vehicle 100 may include, for example, one or more of a speed of the vehicle 100, an acceleration of the vehicle 100, a deceleration of the vehicle 100, a position of a steering wheel of the vehicle 100 (such as a quantity of degrees clockwise or counterclockwise from a center position of the steering wheel), a quantity of revolutions per minute (RPMs) associated with an engine of the vehicle 100, a gear engaged by a transmission of the vehicle 100, a state of a turn signal of the vehicle 100, a state of a windshield wiper of the vehicle 100, a state of a seatbelt of the vehicle 100 (such as whether the seatbelt is employed or unemployed), or a number of occupants of the vehicle, a position of the occupants within the vehicle 100, one or more other states associated with the vehicle 100, or a combination thereof.

In some examples, the one or more states of the driver of the vehicle 100 may include an indication of whether or not inattention or drowsiness of the driver is detected, whether or not cell phone usage (such as texting or a voice call) by the driver is detected, one or more other states associated with the driver, or a combination thereof. To illustrate, in some examples, the cabin-facing camera 114 of the vehicle 100 may capture images or video of the driver of the vehicle 100, which may indicate inattention or drowsiness of the driver (such as if the head of the driver is turned for at least a threshold duration of time or if the eyes of the driver are closed for at least a threshold duration of time) or cell phone usage of the driver. Alternatively, or in addition, inattention or drowsiness of the driver may be detected based on operation of the vehicle 100, such as based on sudden motion of the steering wheel of the vehicle 100 or sudden application of the brakes of the vehicle 100. Alternatively, or in addition, inattention or drowsiness of the driver may be detected based on a wearable device (such as a smart watch) that monitors health data associated with the driver.

The priority-based data migration engine 222 may receive the data (such as the first data 302 and the second data 352) and may prioritize the data in accordance with a prioritization scheme 324. For example, the priority-based data migration engine 222 may assign a first priority 304 to the first data 302 based on the prioritization scheme 324 and may assign a second priority 354 to the second data 352 based on the prioritization scheme 324. The first priority 304 may exceed the second priority 354 (e.g., where the first data 302 is prioritized, where the second data 352 is deprioritized, or both).

In some examples, the prioritization scheme 324 may specify that critical states may be prioritized over noncritical states. To illustrate, the priority-based data migration engine 222 may assign the first priority 304 to the first data 302 based on the first data 302 indicating one or more of a critical vehicle state 306 associated with the vehicle 100 or a critical driver state 308 associated with the driver of the vehicle 100. In some examples, the priority-based data migration engine 222 may assign the second priority 354 to the second data 352 based on the second data 352 indicating one or more of a noncritical vehicle state 356 associated with the vehicle 100 or a noncritical driver state 358 associated with the driver of the vehicle 100.

As referred to herein, a critical state may refer to a state that is outside a reference range of states or values. As referred to herein, a noncritical state may refer to a state that is within the reference range of states or values or to a state for which the reference range of states or values is inapplicable. For example, a speed of the vehicle 100 exceeding a reference speed range may correspond to a critical state, and a speed of the vehicle 100 that does not exceed the reference speed range may correspond to a noncritical state. Further, in some examples, the reference range of states or values may be inapplicable to one or more types of states. For example, the reference range of states or values may be inapplicable to a radio station played by an entertainment system of the vehicle 100. Accordingly, data indicating the radio station may correspond to noncritical data.

To further illustrate, in some examples, the critical vehicle state 306 may include one or more of a speed of the vehicle 100 exceeding a threshold speed, an acceleration of the vehicle 100 exceeding a threshold acceleration, a deceleration of the vehicle 100 exceeding a threshold deceleration, a quantity of RPMs associated with an engine of the vehicle 100 exceeding a threshold quantity of RPMs, a seatbelt of the vehicle 100 being unemployed, one or more other critical states associated with the vehicle 100, or a combination thereof. In some examples, the critical driver state 308 may include one or more of an inattentive state of the driver of the vehicle 100, a drowsy state of the driver of the vehicle 100, or a texting state associated with the driver of the vehicle 100.

Further, in some examples, the noncritical vehicle state 356 may include one or more of a speed of the vehicle 100 failing to exceed a threshold speed, an acceleration of the vehicle 100 failing to exceed a threshold acceleration, a deceleration of the vehicle 100 failing to exceed a threshold deceleration, a position of a steering wheel of the vehicle 100 (such as a quantity of degrees clockwise or counterclockwise from a center position of the steering wheel), a quantity of RPMs associated with an engine of the vehicle 100 failing to exceed a threshold quantity of RPMs, a gear engaged by a transmission of the vehicle 100, a state of a turn signal of the vehicle 100, a state of a windshield wiper of the vehicle 100, a seatbelt of the vehicle 100 being employed, or a number of occupants of the vehicle, a position of the occupants within the vehicle 100, one or more other states associated with the vehicle 100, or a combination thereof. In some examples, the critical driver state 308 may include one or more of an attentive state of the driver of the vehicle 100, a non-drowsy state of the driver of the vehicle 100, or a non-texting state associated with the driver of the vehicle 100.

Accordingly, in some examples, the priority-based data migration engine 222 may receive data and may prioritize the data based on whether the data indicates one or more of a critical vehicle state or a critical driver state. For example, the priority-based data migration engine 222 may receive the first data 302 and may assign the first priority 304 (e.g., a high priority) to the first data 302 based on the first data 302 indicating one or more of the critical vehicle state 306 or the critical driver state 308. As another example, the priority-based data migration engine 222 may receive the second data 352 and may assign the second priority 354 (e.g., a low priority) to the second data 352 based on the second data 352 failing to indicate one or more of a critical vehicle state or a critical driver state.

In some examples, at least some data received by the priority-based data migration engine 222 may include metadata. For example, the first data 302 may include metadata 310, and the second data 352 may include metadata 360. In some examples, the metadata 310 may include one or more timestamps indicating one or more of a time associated with the critical vehicle state 306 or a time associated with the critical driver state 308. In some examples, the metadata 360 may include one or more timestamps indicating one or more of a time associated with the critical vehicle state 306 or a time associated with the critical driver state 308.

In some examples, data may be reported to the priority-based data migration engine 222 on a periodic basis, a semi-periodic basis, or a nonperiodic basis. To illustrate, some data may be reported on a periodic basis, such as where a camera may report image frames to the priority-based data migration engine 222 on a periodic basis. Alternatively, or in addition, at least some data may be reported to the priority-based data migration engine 222 on a nonperiodic basis. For example, in some implementations, a speed of the vehicle 100 may be reported to the priority-based data migration engine 222 based on the speed exceeding a threshold speed (while speeds of the vehicle 100 that fail to exceed the threshold speed may not be reported to the priority-based data migration engine 222).

The priority-based data migration engine 222 may store data to the volatile memory 220 in accordance with the prioritization scheme 324. To illustrate, in some examples, the prioritization scheme 324 may specify that data associated with the first priority 304 may be stored to the volatile memory 220 with greater priority than data associated with the second priority 354. In some examples, data associated with the first priority 304 may be stored to the volatile memory 220 prior to or without storing data associated with the second priority 354 to the volatile memory 220. To further illustrate, in some examples, the priority-based data migration engine 222 may store the first data 302 to the volatile memory 220 based on identifying that the first data 302 is associated with the first priority 304. Further, the priority-based data migration engine 222 may discard the second data 352 (e.g., without storing the second data 352 to the volatile memory 220) based on identifying that the second data 352 is associated with the second priority 354. In some examples, the critical data 228 may include or may correspond to the first data 302.

In some implementations, the prioritization scheme 324 may specify one or more other conditions associated with storing data to the volatile memory 220. The one or more other conditions may include conditions for writing data to the volatile memory 220, conditions for erasing data from the volatile memory 220, conditions for overwriting data at the volatile memory 220, conditions for invalidating data at the volatile memory 220, one or more other conditions, or a combination thereof.

For example, in some implementations, the prioritization scheme 324 may specify that data of a particular data type is to be overwritten at the volatile memory 220 with data of the same data type. To illustrate, data indicating a state of the driver of the vehicle 100 at a first time may be overwritten with data indicating the state of the driver at a second time. In such examples, the data type of the data may correspond to a driver state data type.

Alternatively, or in addition, the prioritization scheme 324 may specify that data is to be stored to the volatile memory 220 based on the data indicating a change of state. In such examples, the prioritization scheme 324 may specify that data is not to be stored to the volatile memory 220 if the data does not indicating a change of state. For example, the prioritization scheme 324 may specify that the data indicating the state of the driver of the vehicle 100 at a first time may be overwritten with data indicating the state of the driver at a second time if the state of the driver at the second time is different than the state of the driver at the first time.

In some circumstances, the priority-based data migration engine 222 may detect a data migration trigger event 326 associated with migration of at least some of the critical data 228 from the volatile memory 220 to the nonvolatile memory 230. In some examples, the data migration trigger event 326 may indicate or may be associated with a potential power interruption at the vehicle 100, a potential collision associated with the vehicle, or another type of event. To further illustrate, in some examples, the data migration trigger event 326 may include one or more of a speed of the vehicle 100 exceeding a threshold speed, an acceleration of the vehicle 100 exceeding a threshold acceleration, a deceleration of the vehicle 100 exceeding a threshold deceleration, an accident (e.g., based on data from one or more impact sensors of the vehicle 100), airbag deployment of one or more airbags of the vehicle 100, inattention or drowsiness of the driver of the vehicle 100, a mechanical issue associated with the vehicle 100 (such as overheating or potential overheating), a particular sound (such as an exclamation by an occupant of the vehicle 100), one or more other events, or a combination thereof.

In some implementations, the data migration trigger event 326 may be associated with a loss of power to the volatile memory 220, which may cause data loss at the volatile memory 220. To illustrate, in some implementations, the volatile memory 220 may be connected to an alternator of the vehicle 100 but not to a battery of the vehicle 100. As a result, if a propulsion system (e.g., motor) of the vehicle 100 is deactivated in association with the data migration trigger event 326, data stored at the volatile memory 220 may be lost if the data is not migrated to the nonvolatile memory 230.

Based on detecting the data migration trigger event 326, the priority-based data migration engine 222 may initiate a data migration operation 350 to migrate at least some of the critical data 228 from the volatile memory 220 to the nonvolatile memory 230. For example, based on detecting the data migration trigger event 326, the priority-based data migration engine 222 may read at least some of the critical data 228 from the volatile memory 220 and may write at least some of the read data to the nonvolatile memory 230.

In some examples, the critical data 228 may be stored to the secure region 232 of the nonvolatile memory 230 in accordance with a data security protocol. In some examples, the data security protocol may correspond a replay protected memory block (RPMB) data security protocol. To illustrate, the nonvolatile memory 230 may operate in accordance with a Universal Flash Storage (UFS) protocol, and the secure region 232 may correspond to an RPMB storage region associated with the UFS protocol. In some other implementations, the critical data 228 may be stored to the nonvolatile memory 230 in accordance with a nonvolatile memory express (NVMe) protocol, and the secure region 232 may correspond to an encrypted region or another secure region associated with the NVMe protocol. Other examples are also within the scope of the disclosure.

In some examples, the priority-based data migration engine 222 may store the critical data 228 to the nonvolatile memory 230 using a prioritized write operation. The prioritized write operation may have priority over other types of operations performed at the nonvolatile memory 230, such as read operations or nonprioritized write operations. To illustrate, prior to performing the data migration operation 350, at least one other operation (such as a read operation or a nonprioritized write operation) may be initiated at the nonvolatile memory 230. In connection with the data migration operation 350, the priority-based data migration engine 222 may provide a dedicated write command 340 to the nonvolatile memory 230 with the critical data 228. The dedicated write command 340 may indicate that the storing of the critical data 228 is prioritized over the at least one other operation.

In some examples, upon receiving the dedicated write command 340, nonvolatile memory 230 may interrupt or abandon the at least one other operation. In some examples, the nonvolatile memory 230 may resume the at least one other operation after completing storing of the critical data 228 (e.g., to the secure region 232) or may generate a notification of failure of the at least one other operation. To further illustrate, in some examples, the at least one other operation may include storing of the second data 352 (or other data) to the nonvolatile memory 230 or reading of data from the nonvolatile memory 230.

One or more features associated with the priority-based data migration engine 222 and the prioritization scheme 324 may be configurable, such as via an interface of the vehicle 100. As an illustrative example, the particular types of states that are associated with the first priority 304 may be configurable via the interface. As another illustrative example, a storage size of the volatile memory 220 reserved for storing the critical data 228 may be configurable via the interface. Depending on the implementation, the interface may include a wired interface, such as via an on-board diagnostics (OBD) interface that may be included in the vehicle 100, or a wireless interface of the vehicle 100. In another example, the interface may include a graphical user interface (GUI) presented via a touchscreen of the display 214. In some examples, the interface may be included in the I/O components 216.

Alternatively, or in addition, in some implementations, the particular data migration trigger event 326 may be configurable via the interface. To illustrate, in some examples, the particular data migration trigger event 326 may be configurable based on one or more of location, time, date, or driver profile. Accordingly, in some examples, different locations, times, dates, or driver profiles may be associated with different respective data migration trigger events 326.

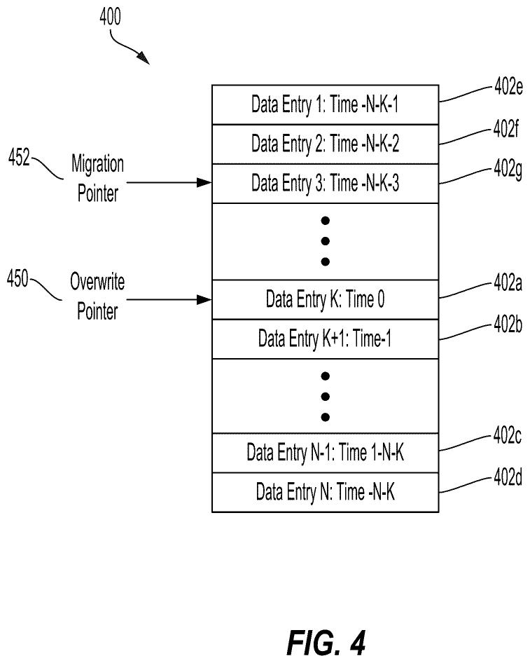

In some examples, the priority-based data migration engine 222 may retrieve data from the volatile memory 220 in accordance with a data migration scheme 328. In some examples, the data migration scheme 328 may specify prioritization associated with reading data from the volatile memory 220, and the prioritization scheme 324 may specify prioritization associated with writing data to the volatile memory 220. Some illustrative examples that may be associated with the data migration scheme 328 are described further with reference to FIG. 4.

FIG. 4 shows a block diagram of an example of a data structure 400 that supports priority-based data migration for a vehicle, such as the vehicle 100 of FIG. 1. The data structure 400 may be associated with data stored at the volatile memory 220, such as one or more of the critical data 228 or the first data 302. In some examples, the data associated with the data structure 400 may include data entries 402a, 402b, 402c, 402d, 402e, 402f, and 402g (also referred to herein as data entries 402a-g). In some examples, one or more of the critical data 228 or the first data 302 may include the data entries 402a-g.

In some examples, each of the data entries 402a-g may be associated with a respective index value. The index values may include the index values indicated in the example of Table 1:

TABLE 1

| Data Entry | Index Value |
|---|---|
| Data Entry 402a | Index Value K |
| Data Entry 402b | Index Value K + 1 |
| Data Entry 402c | Index Value N − 1 |
| Data Entry 402d | Index Value N |
| Data Entry 402e | Index Value 1 |
| Data Entry 402f | Index Value 2 |
| Data Entry 402g | Index Value 3 |

In the example of Table 1, K and N may each indicate an integer greater than or equal to zero. Further, each of the data entries 402a-g may be associated with a respective timestamp. The timestamps may include the timestamps indicated in the example of Table 2:

TABLE 2

| Data Entry | Timestamp |
|---|---|
| Data Entry 402a | Timestamp 0 |
| Data Entry 402b | Timestamp −1 |
| Data Entry 402c | Timestamp 1 − N − K |
| Data Entry 402d | Timestamp −N − K |
| Data Entry 402e | Timestamp −N − K − 1 |
| Data Entry 402f | Timestamp −N − K − 2 |
| Data Entry 402g | Timestamp −N − K − 3 |

In the example of Table 2, K and N may each indicate an integer greater than or equal to zero. In some examples, the metadata 310 of FIG. 3 may include any of the index values of Table 1 or the timestamps of Table 2.

In some implementations, the data structure 400 may specify one or more of an overwrite pointer 450 or a migration pointer 452. In some examples, the overwrite pointer 450 may enable of overwriting of data at the volatile memory 220 in accordance with the prioritization scheme 324 of FIG. 3. For example, in some implementations, the prioritization scheme 324 may specify that the overwrite pointer 450 is to point to a most recently written entry of the volatile memory 220. In such examples, data may be written to the volatile memory 220 according to a last-in, first-out (LIFO) policy.

Further, in some examples, data may be overwritten at the volatile memory 220 in accordance with one or more data types of the data. For example, data of a particular data type may be overwritten with data of the same data type (but not with data of another data type). As an illustrative example, in some implementations, data indicating a driver state may be overwritten with subsequent data indicating a subsequent driver state but not with data indicating a vehicle state, such as speed of the vehicle 100. In some such examples, the data structure 400 may include a different overwrite pointer 450 for each such data type. For example, the data structure 400 may include an overwrite pointer 450 for driver states and another overwrite pointer for vehicle speed. Other examples are also within the scope of the disclosure.

In some examples, data may be retrieved from the volatile memory 220 and stored to the nonvolatile memory 230 in accordance with the migration pointer 452 (e.g., during the data migration operation 350, which may be performed in accordance with detection of the data migration trigger event 326). The migration pointer 452 may operate in accordance with the data migration scheme 328.

To illustrate, in some examples, the data migration scheme 328 may indicate that data is prioritized for migration from the volatile memory 220 to the nonvolatile memory 230 over other data stored at the volatile memory 220 in accordance with the data being associated with a more recent timestamp as compared to the other data. In such examples, the migration pointer 452 may indicate (e.g., point to) a data entry associated with a most recent timestamp of the data entries 402a-g.

In another example, the data migration scheme 328 may indicate that data is prioritized for migration from the volatile memory 220 to the nonvolatile memory 230 over other data stored at the volatile memory 220 in accordance with the data being associated with a more critical event type as compared to the other data. In such examples, the migration pointer 452 may indicate (e.g., point to) a data entry associated with a most critical event type of the data entries 402a-g. As an example, in some implementations, a data entry indicating an inattentive or drowsy state of the driver of the vehicle 100 may be prioritized over a data entry indicating a speed of the vehicle 100 that is within a reference speed range.

Further, it is noted that different data types of data stored at the volatile memory 220 may each be associated with a respective migration pointer 452. To illustrate, in some examples, the data entries 402a-g may include data entries indicating multiple driver states of a driver of the vehicle 100 (e.g., where each driver state is associated with a different respective timestamp). The data entries may be associated with a migration pointer 452 that indicates (e.g., points to) the data entry having the most recent state of the driver. The data entries 402a-g may further include data entries indicating multiple speeds of the vehicle 100 (e.g., where each speed is associated with a different respective timestamp). The data entries may be associated with a migration pointer 452 that indicates (e.g., points to) the data entry having the most recent speed of the vehicle 100.

Accordingly, data may be written to the volatile memory 220 on a prioritized basis (e.g., where the overwrite pointer 450 operates in accordance with the prioritization scheme 324 of FIG. 3). In addition, data may read from the volatile memory 220 from the volatile memory 220 on a prioritized basis (e.g., where the migration pointer 452 operates in accordance with the data migration scheme 328 of FIG. 3). Accordingly, the likelihood of writing the most critical data to the nonvolatile memory 230 may be increased, even in cases where power may be lost at the volatile memory 220 (such as in the event of an accident).

By migrating data from the volatile memory to the nonvolatile memory, data may be more likely to be preserved in case of power loss to the nonvolatile memory (which may occur in some circumstances, such as due to an accident or due to disconnection of a battery of the vehicle). In some examples, the data may be used to investigate a cause of an accident. In some other examples, the data may be used in connection with vehicle diagnostics or performance evaluation, as illustrative examples. Accordingly, one or more features described herein may enable critical data to may be prioritized and preserved for a variety of different uses.

By migrating the critical data 228 from the volatile memory 220 to the nonvolatile memory 230, data may be more likely to be preserved in case of power loss to the volatile memory 220 (which may occur in some circumstances, such as due to an accident associated with the vehicle 100 or due to disconnection of a battery of the vehicle 100). In some examples, the critical data 228 may be used to investigate a cause of an accident. In some other examples, the critical data 228 may be used in connection with vehicle diagnostics or performance evaluation, as illustrative examples. Accordingly, one or more features described herein may enable critical data to may be prioritized and preserved for a variety of different uses.

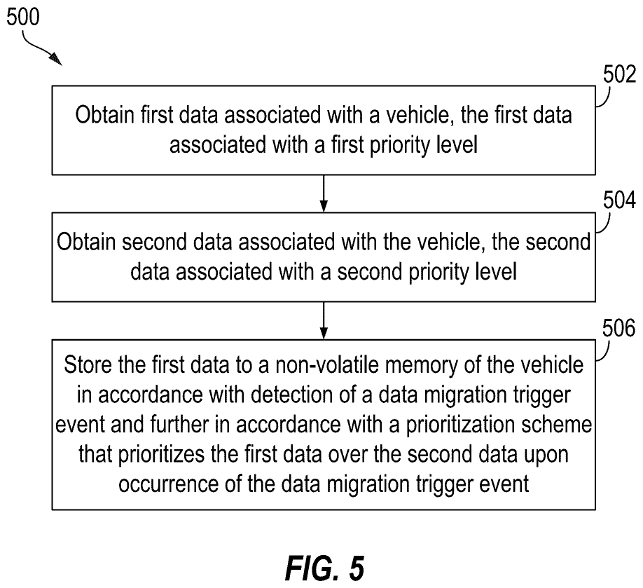

FIG. 5 is a flow chart illustrating an example method 500 that supports data migration for a vehicle, such as the vehicle 100 of FIG. 1. In some examples, one or more operations of the method 500 may be performed by the priority-based data migration engine 222.

The method 500 includes obtaining first data associated with a vehicle, at 502. The first data is associated with a first priority level. For example, the priority-based data migration engine 222 may receive the first data 302 associated with the first priority 304.

The method 500 further includes obtaining second data associated with the vehicle, at 504. The second data is associated with a second priority level. For example, the priority-based data migration engine 222 may receive the second data 352 associated with the second priority 354.

The method 500 further includes storing the first data to a nonvolatile memory of the vehicle in accordance with detection of a data migration trigger event and further in accordance with a prioritization scheme that prioritizes the first data over the second data upon occurrence of the data migration trigger event, at 506. For example, the priority-based data migration engine 222 may store the first data 302 to the nonvolatile memory 230 in accordance with detection of the data migration trigger event 326 and further in accordance with the prioritization scheme 324. The prioritization scheme 324 may prioritize storing of data associated with the first priority 304 (such as the first data 302) to the nonvolatile memory 230 over storing of data associated with the second priority 354 (such as the second data 352) to the nonvolatile memory 230.

In a first aspect, a processing system includes one or more memories and one or more processors coupled to the one or more memories. The processing system is configured to obtain first data associated with a vehicle and to obtain second data associated with the vehicle. The first data is associated with a first priority level, and the second data is associated with a second priority level. The processing system is further configured to store the first data to a nonvolatile memory of the vehicle in accordance with detection of a data migration trigger event and further in accordance with a prioritization scheme that prioritizes the first data over the second data upon occurrence of the data migration trigger event.

In a second aspect, in combination with the first aspect, the first data indicates one or more of a critical vehicle state associated with the vehicle or a critical driver state associated with a driver of the vehicle, and the second data indicates one or more of a noncritical vehicle state associated with the vehicle or a noncritical driver state associated with the driver.

In a third aspect, in combination with one or more of the first aspect or the second aspect, the one or more memories include a volatile memory of the vehicle, and the processing system is further configured to retrieve, prior to storing the first data to the nonvolatile memory, the first data from the volatile memory in accordance with a data migration scheme.

In a fourth aspect, in combination with one or more of the first aspect through the third aspect, the data migration scheme indicates that the first data is prioritized for migration from the volatile memory to the nonvolatile memory over other data stored at the volatile memory in accordance with the first data being associated with a more recent timestamp as compared to the other data.

In a fifth aspect, in combination with one or more of the first aspect through the fourth aspect, the data migration scheme indicates that the first data is prioritized for migration from the volatile memory to the nonvolatile memory over other data stored at the volatile memory in accordance with the first data being associated with a more critical event type as compared to the other data.

In a sixth aspect, in combination with one or more of the first aspect through the fifth aspect, the processing system is further configured to store the first data to a secure region of the nonvolatile memory in accordance with a data security protocol.

In a seventh aspect, in combination with one or more of the first aspect through the sixth aspect, the processing system is further configured to initiate at least one other operation at the nonvolatile memory and to provide a dedicated command to the nonvolatile memory with the first data. The dedicated command indicates that storing of the first data to the nonvolatile memory is prioritized over the at least one other operation.

In an eighth aspect, a method includes obtaining first data associated with a vehicle and further includes obtaining second data associated with the vehicle. The first data associated with a first priority level, and the second data is associated with a second priority level. The method further includes storing the first data to a nonvolatile memory of the vehicle in accordance with detection of a data migration trigger event and further in accordance with a prioritization scheme that prioritizes the first data over the second data upon occurrence of the data migration trigger event.

In a ninth aspect, in combination with the eighth aspect, the first data indicates one or more of a critical vehicle state associated with the vehicle or a critical driver state associated with a driver of the vehicle, and the second data indicates one or more of a noncritical vehicle state associated with the vehicle or a noncritical driver state associated with the driver.

In a tenth aspect, in combination with one or more of the eighth aspect through the ninth aspect, the method further includes, prior to storing the first data to the nonvolatile memory, retrieving the first data from a volatile memory of the vehicle in accordance with a data migration scheme.

In an eleventh aspect, in combination with one or more of the eighth aspect through the tenth aspect, the data migration scheme indicates that the first data is prioritized for migration from the volatile memory to the nonvolatile memory over other data stored at the volatile memory in accordance with the first data being associated with a more recent timestamp as compared to the other data.

In a twelfth aspect, in combination with one or more of the eighth aspect through the eleventh aspect, the data migration scheme indicates that the first data is prioritized for migration from the volatile memory to the nonvolatile memory over other data stored at the volatile memory in accordance with the first data being associated with a more critical event type as compared to the other data.

In a thirteenth aspect, in combination with one or more of the eighth aspect through the twelfth aspect, the first data is stored to a secure region of the nonvolatile memory in accordance with a data security protocol.

In a fourteenth aspect, in combination with one or more of the eighth aspect through the thirteenth aspect, the method further includes at least one other operation at the nonvolatile memory, and storing the first data to the nonvolatile memory includes providing a dedicated command to the nonvolatile memory with the first data. The dedicated command indicates that storing of the first data to the nonvolatile memory is prioritized over the at least one other operation.

In a fifteenth aspect, a non-transitory computer-readable medium stores instructions executable by one or more processors to perform operations. The operations include obtaining first data associated with a vehicle and further include obtaining second data associated with the vehicle. The first data associated with a first priority level, and the second data is associated with a second priority level. The operations further include storing the first data to a nonvolatile memory of the vehicle in accordance with detection of a data migration trigger event and further in accordance with a prioritization scheme that prioritizes the first data over the second data upon occurrence of the data migration trigger event.

In a sixteenth aspect, in combination with the fifteenth aspect, the first data indicates one or more of a critical vehicle state associated with the vehicle or a critical driver state associated with a driver of the vehicle, and the second data indicates one or more of a noncritical vehicle state associated with the vehicle or a noncritical driver state associated with the driver.

In a seventeenth aspect, in combination with one or more of the fifteenth aspect through the sixteenth aspect, the instructions are further executable by the one or more processors to retrieve, prior to storing the first data to the nonvolatile memory, the first data from a volatile memory of the vehicle in accordance with a data migration scheme.

In an eighteenth aspect, in combination with one or more of the fifteenth aspect through the seventeenth aspect, the data migration scheme indicates that the first data is prioritized for migration from the volatile memory to the nonvolatile memory over other data stored at the volatile memory in accordance with the first data being associated with a more recent timestamp as compared to the other data.

In a nineteenth aspect, in combination with one or more of the fifteenth aspect through the eighteenth aspect, the data migration scheme indicates that the first data is prioritized for migration from the volatile memory to the nonvolatile memory over other data stored at the volatile memory in accordance with the first data being associated with a more critical event type as compared to the other data.

In a twentieth aspect, in combination with one or more of the fifteenth aspect through the nineteenth aspect, the instructions are further executable by the one or more processors to store the first data is stored to a secure region of the nonvolatile memory and using a dedicated command indicating that storing of the first data to the nonvolatile memory is prioritized over at least one other operation associated with the nonvolatile memory.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus comprising:
a processing system comprising one or more memories and one or more processors coupled to the one or more memories, the processing system configured to:
obtain first data associated with a vehicle, the first data associated with a first priority level;
obtain second data associated with the vehicle, the second data associated with a second priority level; and
store the first data to a nonvolatile memory of the vehicle in accordance with detection of a data migration trigger event and further in accordance with a prioritization scheme that prioritizes the first data over the second data upon occurrence of the data migration trigger event.

2. The apparatus of claim 1, wherein the first data indicates one or more of a critical vehicle state associated with the vehicle or a critical driver state associated with a driver of the vehicle, and wherein the second data indicates one or more of a noncritical vehicle state associated with the vehicle or a noncritical driver state associated with the driver.

3. The apparatus of claim 1, wherein the one or more memories include a volatile memory of the vehicle, and wherein the processing system is further configured to retrieve, prior to storing the first data to the nonvolatile memory, the first data from the volatile memory in accordance with a data migration scheme.

4. The apparatus of claim 3, wherein the data migration scheme indicates that the first data is prioritized for migration from the volatile memory to the nonvolatile memory over other data stored at the volatile memory in accordance with the first data being associated with a more recent timestamp as compared to the other data.

5. The apparatus of claim 3, wherein the data migration scheme indicates that the first data is prioritized for migration from the volatile memory to the nonvolatile memory over other data stored at the volatile memory in accordance with the first data being associated with a more critical event type as compared to the other data.

6. The apparatus of claim 1, wherein the processing system is further configured to store the first data to a secure region of the nonvolatile memory in accordance with a data security protocol.

7. The apparatus of claim 1, wherein the processing system is further configured to:
initiate at least one other operation at the nonvolatile memory; and
provide a dedicated command to the nonvolatile memory with the first data, wherein the dedicated command indicates that storing of the first data to the nonvolatile memory is prioritized over the at least one other operation.

8. A method comprising:
obtaining first data associated with a vehicle, the first data associated with a first priority level;
obtaining second data associated with the vehicle, the second data associated with a second priority level; and
storing the first data to a nonvolatile memory of the vehicle in accordance with detection of a data migration trigger event and further in accordance with a prioritization scheme that prioritizes the first data over the second data upon occurrence of the data migration trigger event.

9. The method of claim 8, wherein the first data indicates one or more of a critical vehicle state associated with the vehicle or a critical driver state associated with a driver of the vehicle, and wherein the second data indicates one or more of a noncritical vehicle state associated with the vehicle or a noncritical driver state associated with the driver.

10. The method of claim 8, further comprising, prior to storing the first data to the nonvolatile memory, retrieving the first data from a volatile memory of the vehicle in accordance with a data migration scheme.

11. The method of claim 10, wherein the data migration scheme indicates that the first data is prioritized for migration from the volatile memory to the nonvolatile memory over other data stored at the volatile memory in accordance with the first data being associated with a more recent timestamp as compared to the other data.

12. The method of claim 10, wherein the data migration scheme indicates that the first data is prioritized for migration from the volatile memory to the nonvolatile memory over other data stored at the volatile memory in accordance with the first data being associated with a more critical event type as compared to the other data.

13. The method of claim 8, wherein the first data is stored to a secure region of the nonvolatile memory in accordance with a data security protocol.

14. The method of claim 8, further comprising initiating at least one other operation at the nonvolatile memory, wherein storing the first data to the nonvolatile memory includes providing a dedicated command to the nonvolatile memory with the first data, and wherein the dedicated command indicates that storing of the first data to the nonvolatile memory is prioritized over the at least one other operation.

15. A non-transitory computer-readable medium storing instructions executable by one or more processors to perform operations, the operations comprising:
obtaining first data associated with a vehicle, the first data associated with a first priority level;
obtaining second data associated with the vehicle, the second data associated with a second priority level; and
storing the first data to a nonvolatile memory of the vehicle in accordance with detection of a data migration trigger event and further in accordance with a prioritization scheme that prioritizes the first data over the second data upon occurrence of the data migration trigger event.

16. The non-transitory computer-readable medium of claim 15, wherein the first data indicates one or more of a critical vehicle state associated with the vehicle or a critical driver state associated with a driver of the vehicle, and wherein the second data indicates one or more of a noncritical vehicle state associated with the vehicle or a noncritical driver state associated with the driver.

17. The non-transitory computer-readable medium of claim 15, wherein the instructions are further executable by the one or more processors to retrieve, prior to storing the first data to the nonvolatile memory, the first data from a volatile memory of the vehicle in accordance with a data migration scheme.

18. The non-transitory computer-readable medium of claim 17, wherein the data migration scheme indicates that the first data is prioritized for migration from the volatile memory to the nonvolatile memory over other data stored at the volatile memory in accordance with the first data being associated with a more recent timestamp as compared to the other data.

19. The non-transitory computer-readable medium of claim 17, wherein the data migration scheme indicates that the first data is prioritized for migration from the volatile memory to the nonvolatile memory over other data stored at the volatile memory in accordance with the first data being associated with a more critical event type as compared to the other data.

20. The non-transitory computer-readable medium of claim 15, wherein the instructions are further executable by the one or more processors to store the first data is stored to a secure region of the nonvolatile memory and using a dedicated command indicating that storing of the first data to the nonvolatile memory is prioritized over at least one other operation associated with the nonvolatile memory.
